(19) United States
(12) Patent Application Publication
(10) Pub. No.: US 2016/0255126 A1
(43) Pub. Date: Sep. 1, 2016

(54) Application and method for conducting group video conversations and meetings on mobile communication devices

(71) Applicant: William Sarris, Pebble Beach, CA (US)

(72) Inventor: William Sarris, Pebble Beach, CA (US)

(21) Appl. No.: 14/544,864

(22) Filed: Feb. 26, 2015

(51) Int. Cl. H04L 29/06; H04N 7/14; H04N 7/15

(52) U.S. Cl. CPC H04L 65/1096; H04N 7/155; H04N 7/147; H04N 7/142; H04L 65/1069; H04L 65/1093

(57) ABSTRACT

A downloadable application for mobile communication devices and a method of using said application which moderates and controls the activities of participants in a virtual meeting or videoconference by limiting the number of speakers to one at a time, establishing the order in which the speakers will speak, limiting the amount of time each speaker has to speak, and providing for the entry of a moderator to take direct control over the virtual meeting or videoconference.

### CROSS-REFERENCE TO RELATED APPLICATION

This application claims the benefit of Provisional Patent Application Ser. No. 61/966,714 filed Mar. 1, 2014 by William Sarris, Erik Thomas, and Jared Reed which is incorporated by reference

### FEDERALLY SPONSORED RESEARCH

Not Applicable

### SEQUENCE LISTING OR PROGRAM

Not Applicable

### BACKGROUND OF THE INVENTION

1. Field of the Invention

The present invention relates generally to group video communication and specifically to downloadable and embedded applications for conducting group video conversations and meetings on mobile communication devices such as, without limitation, mobile phones and tablets.

2. Description Of Prior Art

The most basic type of remote group meeting or conference is the telephone conference call. The conference call system entails multiple participants dialing into a multiplex telephone system at a central location thereby permitting a limited number of participants to partake in a multi-party telephone conversation on the same telephone line. This is similar to an actual conversation except that the participants are located in different geographical locations. As with an actual conversation, there can be more than one person speaking at a time over the common telephone line which makes the conversation difficult to follow. Further, multiple parties speaking at the same time will drown out the various inputs and reduce them to noise. Finally, remote group meetings using a conference call option or a multiplex system are typically restricted to a small number of participants because of the limitations of the technology involved. The hardware supporting a conference call involving a large number of participants would be unwieldy, cumbersome and expensive. Further, a large number of participants would likely induce substantial signal degradation causing the transmission to break up or become inaudible.

A more advanced version of the conference call is the teleconference or videoconference which incorporates a video display into the conference call. Videoconferencing is the conduct of a videoconference by a set of telecommunication technologies which allow two or more locations to communicate by simultaneous two-way video and audio transmissions. It has also been called ‘visual collaboration’ and is a type of groupware. Videoconferencing differs from videophone calls in that it's designed to serve a conference or multiple locations rather than individuals. With the introduction of relatively low cost, high capacity broadband telecommunication services in the late 1990s, coupled with powerful computing processors and video compression techniques, videoconferencing has made significant inroads in business, education, medicine and media. Videoconferencing provides participants with the ability to give visual cues to one another and thereby lessen the number of interruptions and instances of multiple parties speaking at the same time. It also provides participants with the additional advantage of incorporating visual aids such as slides, charts, and other such graphics.

Dedicated videoconferencing systems have all of the required components packaged into a single piece of equipment, usually a console with a high quality remotely controlled video camera. The videoconferencing console contains all electrical interfaces, the control computer, and the software or hardware-based codec. Omnidirectional microphones are connected to the console, as well as a TV monitor with loudspeakers and/or a video projector. Commercially, there are several types of dedicated videoconferencing devices based upon the number of intended participants. Large group videoconferencing systems are typically non-portable, quite large and cumbersome, and more expensive systems intended for use in large rooms and auditoriums. Small group videoconferencing systems can be either non-portable or portable and are smaller and less expensive devices that are intended for use in small meeting rooms or offices. Finally, Individual videoconferencing devices are usually portable devices, meant for single users, have fixed cameras, microphones and loudspeakers integrated into the console. However, since videoconferencing, still relies upon a telephone landline system, the shortcomings inherent in the conference call option (multiple participants speaking at the same time and generally smaller groups participating) will also be applicable to the videoconference option as well.

Another type of individual videoconferencing device is the desktop videoconferencing system/device. Desktop videoconferencing systems are typically add-on accessories (hardware boards, usually) to normal personal computers, transforming them into videoconferencing devices. A range of different cameras and microphones can be used with the board, which contains the necessary codec and transmission interfaces to operate the videoconferencing experience. Video-conferences carried out via dispersed PCs are also known as e-meetings.

This is a more advanced type of remote group meeting known as a virtual meeting. Virtual meetings are live, interactive meetings that are held online (i.e., over the Internet). These meetings simultaneously and electronically bring attendees into a single virtual meeting room despite the fact that the attendees are physically located in widely dispersed geographic locations during the course of the virtual meeting. These virtual meetings typically utilize audio, video, and/or textual inputs to permit meeting attendees/participants to communicate with one another.

The popularity and convenience of virtual meetings has given rise to a large library of computer software that allows users to interact with one another in a virtual environment. One example of this type of interaction is that found in an Internet chat room where users interested in a similar subject can remotely meet with each other through a virtual medium and exchange comments, suggestions, and the like with each other. While this utilization of a virtual meeting works reasonably well with a small group of attendees, larger numbers pose problems as more and more users want to express their points of view and they end up interrupting each other or cutting each other out so their comments are lost to the other attendees. To address this problem, certain rules of chat room etiquette have evolved over time. These rules, however, are only effective in maintaining control over the conversation or meeting if they are uniformly observed by all of the attendees. Accordingly, chat rooms are limited to a small number of participants and the problem of participants interrupting each other or multiple participants trying to speak at the same time persist.

The virtual videoconference represents an improvement over the chat room model. Video conferences are also live, interactive meetings that are held online (i.e., over the Internet). These meetings simultaneously and electronically bring attendees into a single virtual meeting room despite the fact that the attendees are physically located in widely dispersed geographic locations during the course of the virtual meeting. These virtual meetings typically utilize audio, video, and/or textual inputs to permit meeting attendees to communicate with one another.

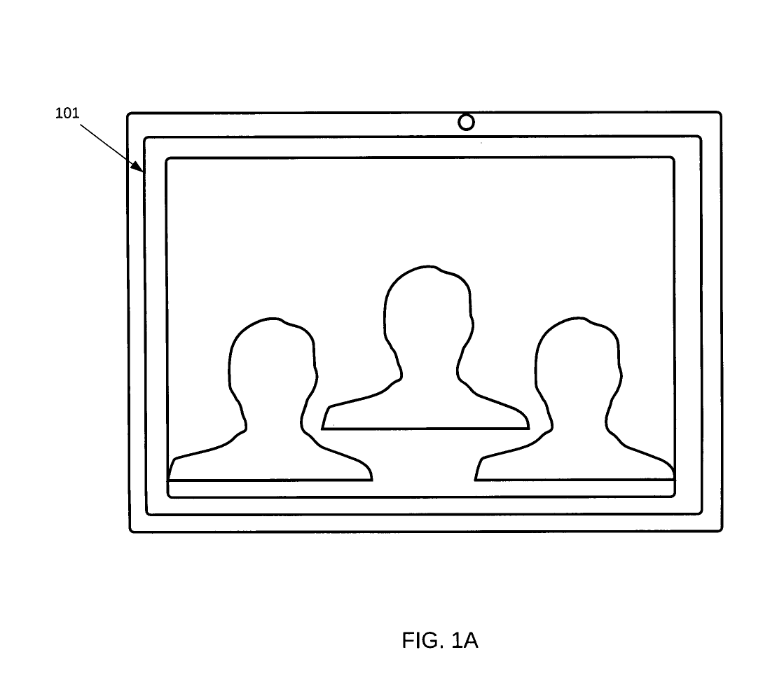

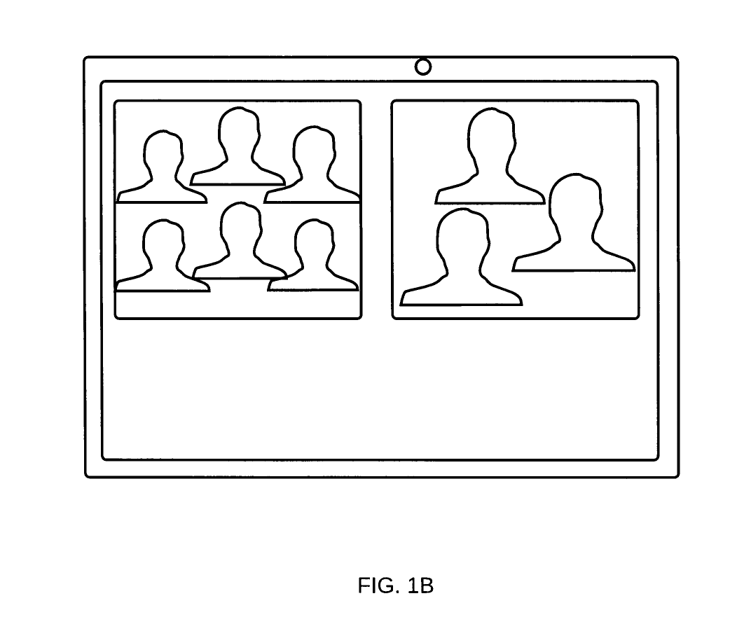

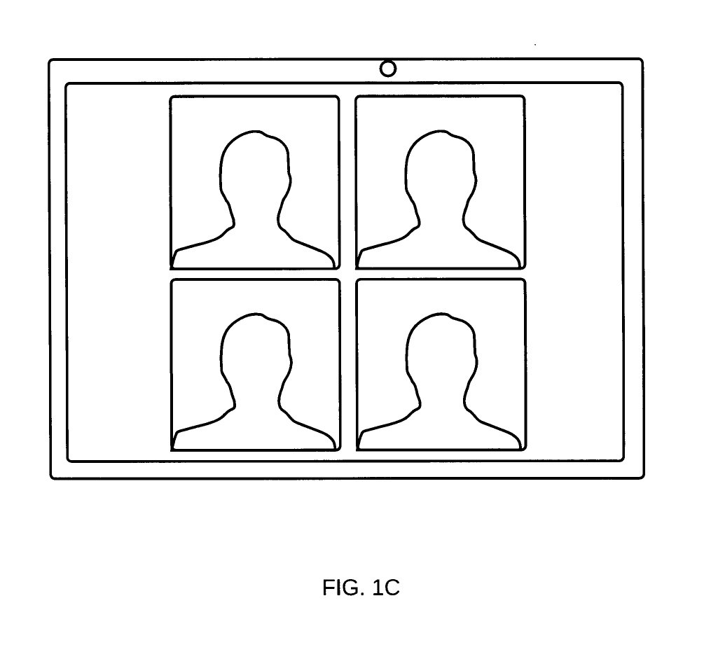

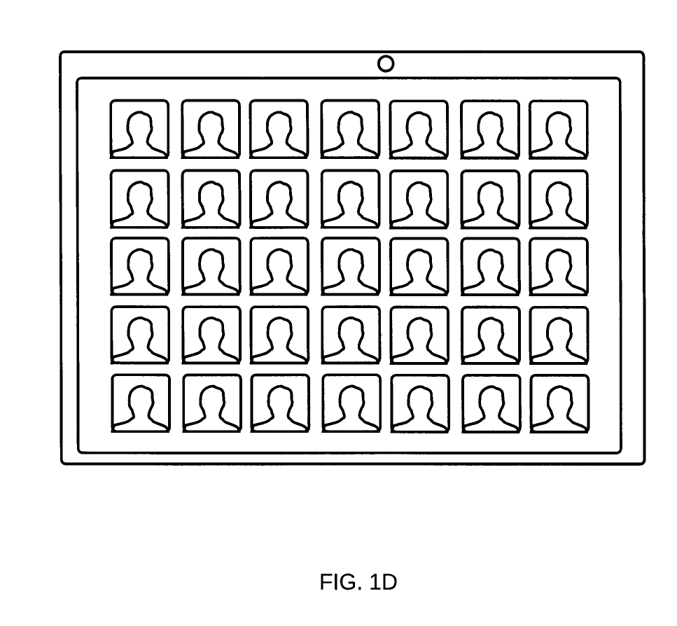

When an individual desires to join or participate in a remote virtual meeting, he/she accesses the Internet web site of the host or sponsor of the desired meeting and completes some administrative process of logging into the meeting and receiving instructions on how to participate. As seen in FIG. 1, each participant's computer screen will typically present a live video display of all of the participants in the virtual meeting with each participant occupying an equal portion or “window” of that section of the screen allocated for displaying visual images of the participants. In this arrangement, each participant sees a visual image of each other participant. The sponsor's web site will typically have a means of activating a microphone using Voice-Over-Internet-Protocol (VOIP) which is a methodology and group of technologies for the delivery of voice communications and multimedia sessions over Internet Protocol (IP) networks, such as the Internet. In this manner, the participants take part in the ongoing discussion or meeting simply by keying their microphones. Since each participant can be seen in the “window” on each participant's computer screen, he/she can add visual content such as slides or other graphic materials to his/her presentation and participation in the virtual meeting.

While the virtual meeting represents a significant improvement over conference calls and videoconferencing, it still inherits the problems associated with those remote group meeting options. Currently, virtual meetings still experience problems with more than one participant speaking at a time. In essence, there is no control over who is speaking and if multiple participants try to speak at the same time, they will cancel out each other's audio input. Further, while virtual meetings could theoretically permit a large number of participants to take part in the meeting, the “window” images of those participants become increasingly smaller as more participants join the meeting because the amount of screen space allocated to displaying images is limited. Any slides or other graphics used by a speaker would not be visible because the “window” has become too small to be useful. Finally, the prior art technology (i.e., the downloadable applications) used to create or support these virtual meetings is currently not compatible with mobile communications devices such as mobile phones or tablets (in this context, “tablets” refers to computer tablets which are mobile computers with a touch-screen display, circuitry, and a battery in a single unit). The present invention provides that compatibility with such mobile communications devices.

These group-size limitations can be seen in FIGS. 1A, 1B, 1C, and 1D. FIG. 1A is a prior art computer screen image of a group video conference with a small number of participants in the same location. As long as this group remains relatively small, all participants will be visible on the computer screen. However, if the size of the group increases to that which is typical of an on-line seminar or classroom (upwards of 10-15 participants), the physical limitations of the computer screen simply will not permit all of the participants to be visible at the same time and the visual clues necessary to maintain order in the meeting would, similarly, not be visible to all of the participants. Referring to FIG. 1B, this size limitation is compounded if participants in the videoconference are not in the same location. The screen dimensions have already been decreased to accommodate the different locations; the more locations participating in the conference, the smaller the screen size. Given that this scenario begins with a reduced screen size, the number of participants at each remote location would be further restricted.

Referring now to FIG. 1C, the screen on the mobile communications device shows a relatively small number of participants in this virtual meeting. Prior art technology provides for posting the images of all virtual meeting participants on the screen at the same time; as such, as long as the number of participants remains relatively small, the images are typically clear and distinct. However, as shown in FIG. 1D, if the number of participants increases, the images shrink in size until these reach a point of diminishing clarity and are no longer distinguishable. While this FIG. 1D shows a relatively small number of participants (twenty), the screen limitations are readily apparent. With meetings, classes, lectures, seminars, etc. often including significantly larger numbers of participants (upwards of 100), it is obvious the applications disclosed by the prior art simply cannot accommodate these bigger groups.

### Objects and Advantages

The present invention has been designed to address the foregoing problems found in the prior art by providing an application for use in conducting group video conversations and meetings on mobile communication devices. These group video conversations may encompass any number of different scenarios that involve numerous fields of endeavor including, without limitation:

(1) Banking functions such as applying for a loan, purchasing a certificate of deposit, opening or closing an account, credit card transactions, and the like where the user desires to interact with one or more bank employees or officers of a given financial institution.

(2) On-line medical interviews where the user desires to consult with one or more health-care professionals at the same time.

(3) On-line educational opportunities where the user desires to participate in an on-line seminar, continuing education class, briefing, lecture, and the like.

(4) On-line business meetings, board meetings, town-hall meetings, informational meetings, and the like.

(5) On-line sales events where the user desires to show merchandise or promotional material to one or more potential buyers at the same time.

(6) Any other such on-line, virtual meeting where the user desires to use a mobile communication device to interact with one or more other individuals participating in that same on-line event.

(7) An on-line social gathering such as a virtual reunion of friends and acquaintances or an on-line book club.

Accordingly, the objects and advantages of the present invention are:

(1) to provide an application for use in conducting group video conversations on mobile communication devices such as, without limitation, a mobile phone or computer tablet.

(2) to provide an application for use in conducting group video conversations on mobile communication devices that limits the number of participants speaking in such a virtual meeting to one speaker at a time.

(3) to provide an application for use in conducting group video conversations on mobile communication devices that determines the order of speakers and the length of time that they may speak.

(4) to provide an application for use in conducting group video conversations on mobile communication devices wherein the participant's mobile communications device does not need other applications installed.

(5) to provide an application for use in conducting group video conversations on mobile communication devices that is Internet specific.

(6) to provide an application for use in conducting group video conversations on mobile communication devices that is targeted to an on-line remote group meeting audience.

(7) to provide an application for use in conducting group video conversations on mobile communication devices that provides for a moderator to maintain order and discipline in the virtual meeting.

(8) to provide an application for use in conducting group video conversations on mobile communication devices that allows the moderator and participants in an on-line conference to talk to each other using Voice over IP technology.

(9) to provide an application for use in conducting group video conversations on mobile communication devices that allows a moderator to coordinate a verbal dialogue among individuals who are geographically dispersed.

(10) to provide an application for use in conducting group video conversations on mobile communication devices, desktop computers, laptop computers, and computer tablets that allows a moderator to coordinate a verbal dialogue among individuals who are on-line.

(11) to provide an application for use in conducting group video conversations on mobile communication devices that allows the participants in an on-line conference to learn more about the appeal and impact of their own products, advertisements, and political campaigns.

(12) to provide an application for use in conducting group video conversations on mobile communication devices wherein entire groups can communicate collectively and simultaneously in a virtual environment.

(13) to provide an application for use in conducting group video conversations on mobile communication devices wherein an observer can anonymously observe and listen to an ongoing Internet conference.

(14) to provide an application for use in conducting group video conversations on mobile communication devices that provides the moderator of an on-line conference with innovative tools to manage the discussion more effectively than in a face-to-face meeting.

(15) to provide an application for use in conducting group video conversations on mobile communication devices that provides for an on-line program administrator who can monitor and interact during sessions to provide technical and instructional assistance.

(16) to provide an application for use in conducting group video conversations on mobile communication devices that allows an on-line moderator or administrator to remove abusive, uncooperative, vulgar, off-topic, etc. participants from the group video conversation.

(17) to provide an application for use in conducting group video conversations on mobile communication devices that allows an on-line moderator or administrator to interrupt a speaker or remove a speaker during his/her presentation.

(18) to provide an application for use in conducting group video conversations on mobile communication devices that allows the moderator and/or participants of an on-line conference to show videos, graphics and images to all participants simultaneously for group presentation and comment.

(19) to provide an application for use in conducting group video conversations on mobile communication devices where the presentation capabilities of slides and videos is not limited to the size of the video image.

(20) to provide an application for use in conducting group video conversations on mobile communication devices that allows hundreds of participants to join and partake in an on-line meeting, conference or discussion.

(21) to provide an application for use in conducting group video conversations on mobile communication devices that determines the order of speakers and displays that order of speaking in a “speakers' queue” that lets participants know the order in which speakers will be allowed to speak and where they stand in the speakers' queue.

(22) to provide an application for use in conducting group video conversations on mobile communication devices that provides participants with a means of entering a queue to participate by speaking one-at-a-time in an ordered fashion.

(23) to provide an application for use in conducting group video conversations on mobile communication devices that provides participants with a means of communicating by text messages with the speaker as well as other participants while the speaker is actually speaking.

(24) to provide an application for use in conducting group video conversations on mobile communication devices that provides an on-line moderator or administrator with a means of communicating by text messages with the speaker as well as other participants while the speaker is actually speaking.

(25) to provide an application for use in conducting group video conversations on mobile communication devices that provides participants with a means of communicating privately with the moderator while an online remote meeting or discussion is in progress.

Additional objects, advantages, and novel features of the invention will be set forth in part of the description which follows, will become apparent to those skilled in the art upon examination of the following specification, or may be learned through the practice of the present invention. Still further objects and advantages of the present invention will become apparent from a consideration of the drawings and the ensuing description of the invention.

### DRAWINGS

### Drawing Figures

FIG. 1A is a prior art computer screen image of a group video conference with a small number of participants in the same location.

FIG. 1B is a prior art computer screen image of a group video conference with two small groups of participants in two different locations.

FIG. 1C is a prior art computer screen image of a group virtual meeting having a small number of participants in different locations.

FIG. 1D is a prior art computer screen image of a group virtual meeting having a large number of participants in different locations.

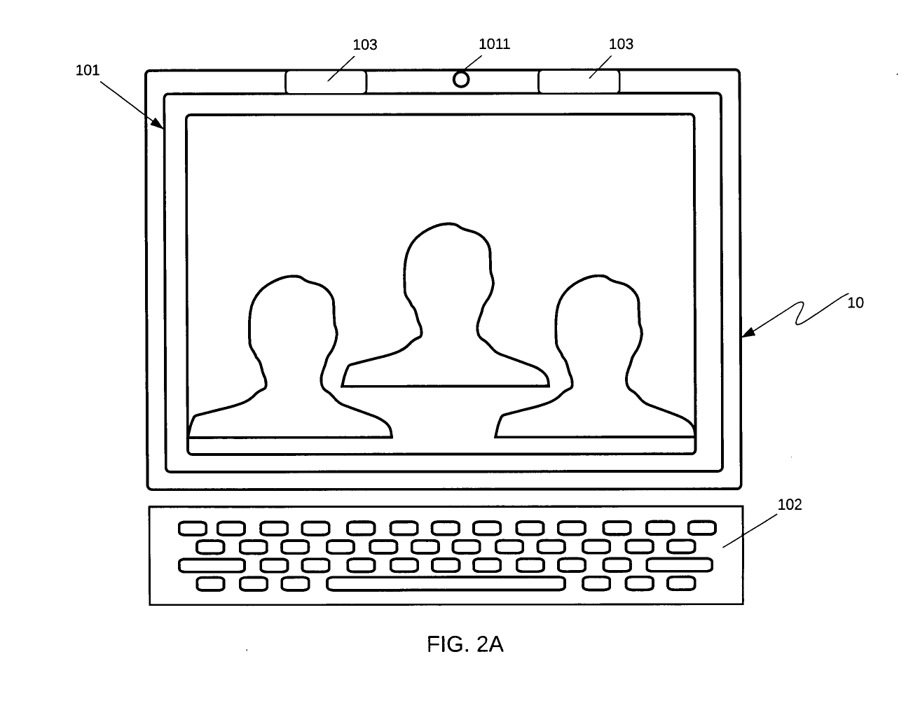

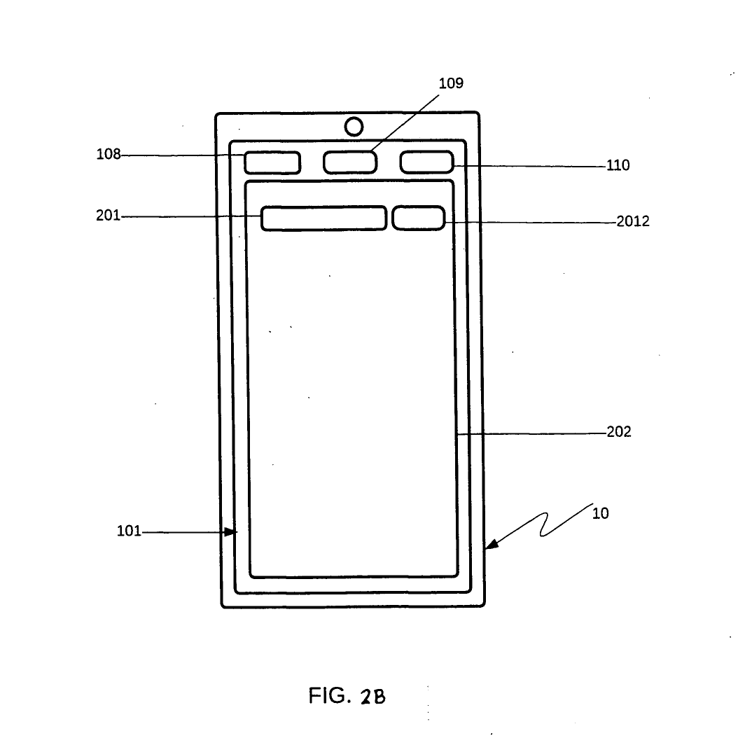

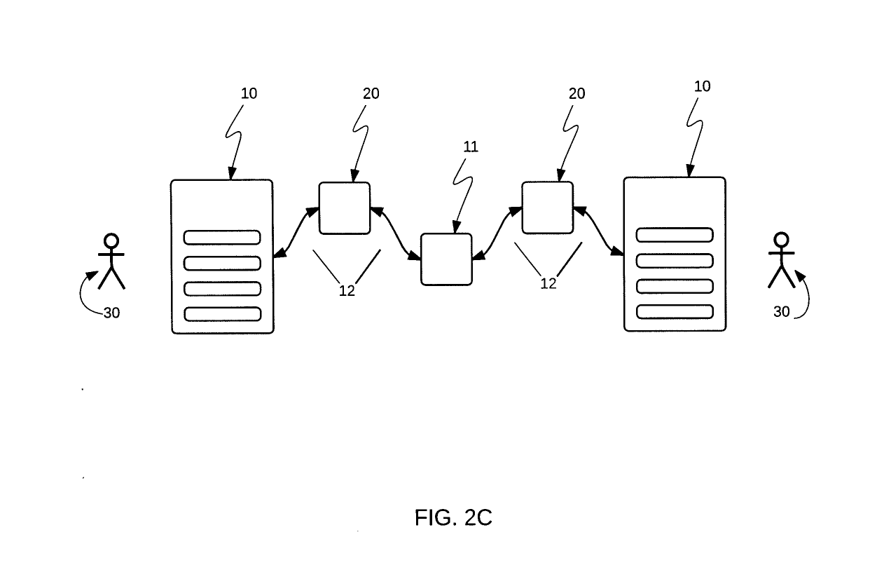

FIG. 2A is a screen view of generic mobile communication device (in this case, a tablet) into which the present invention could be downloaded or embedded as an application.

FIG. 2B is a screen view of a generic mobile communication device (mobile phone) into which the present invention could be downloaded or embedded as an application.

FIG. 2C is a diagram showing the relationship between participants taking part in a virtual meeting.

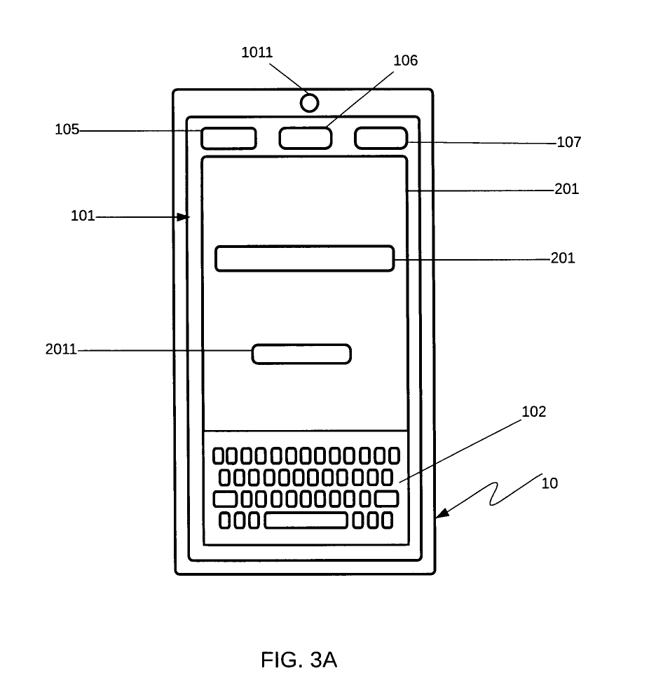

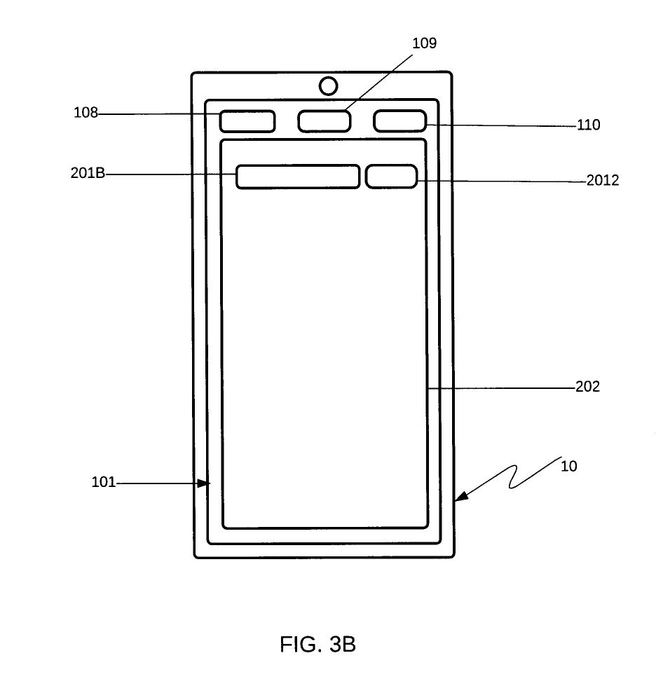

FIG. 3A is a mobile phone screen image giving the participant directions on how to enter a virtual meeting using the present invention.

FIG. 3B is a mobile phone screen image giving the participant instructions on how to participate in a virtual meeting using the present invention.

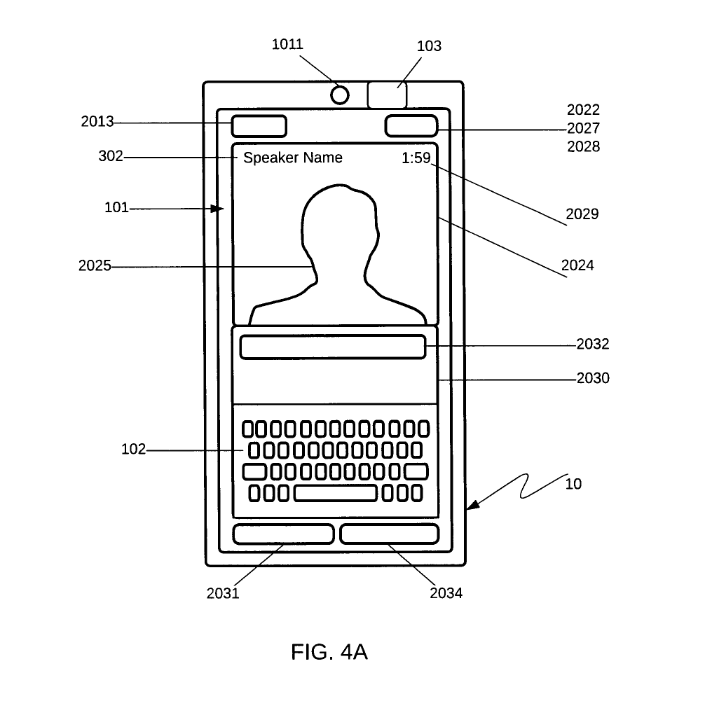

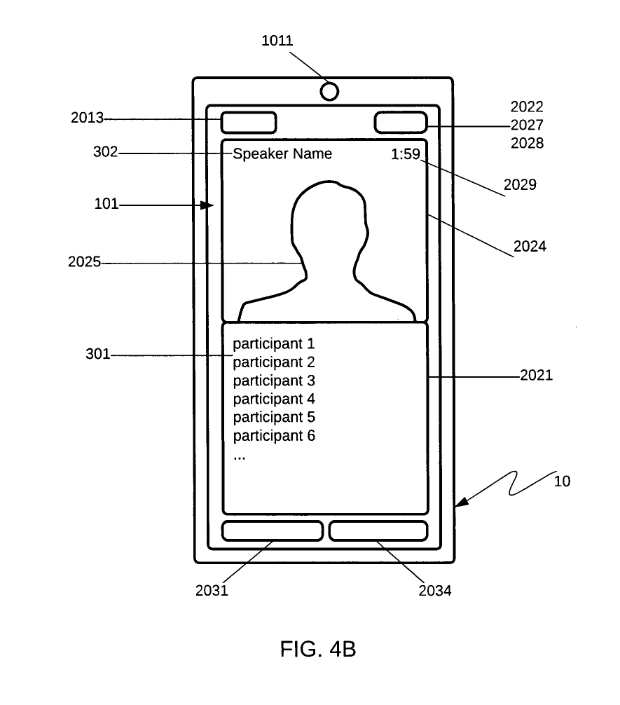

FIG. 4A is mobile phone screen image showing the speaker's image and the text chat screen.

FIG. 4B is mobile phone screen image showing the speaker's image, the name of the administrator, and a list of participants.

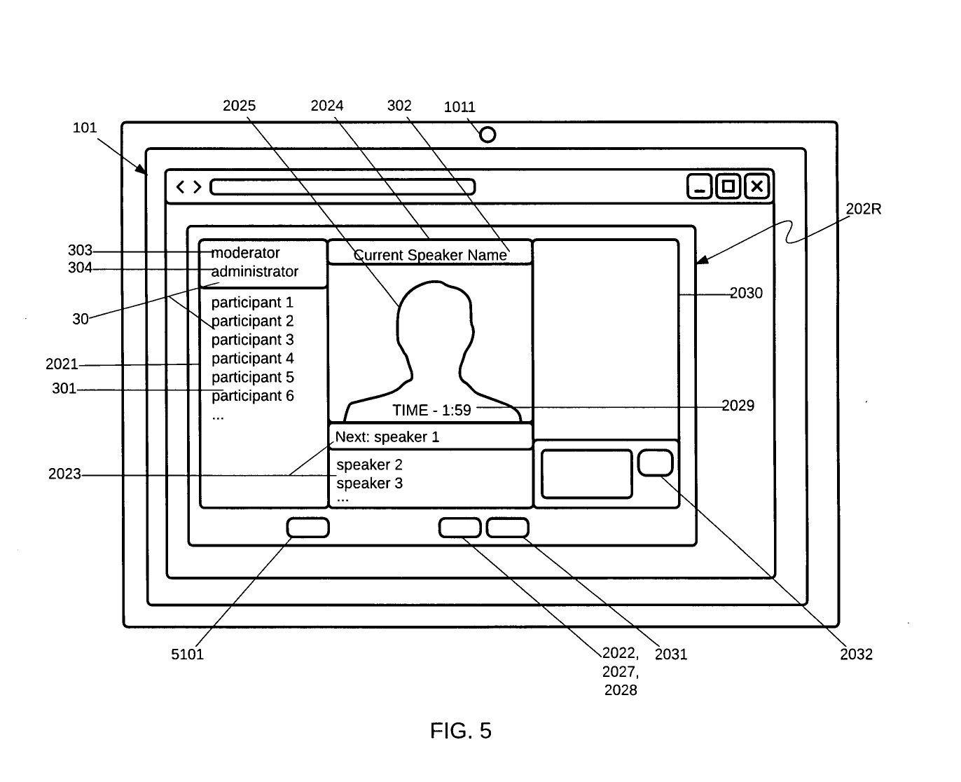

FIG. 5 is a mobile tablet screen image of a virtual meeting room using some of the unique features of the present invention.

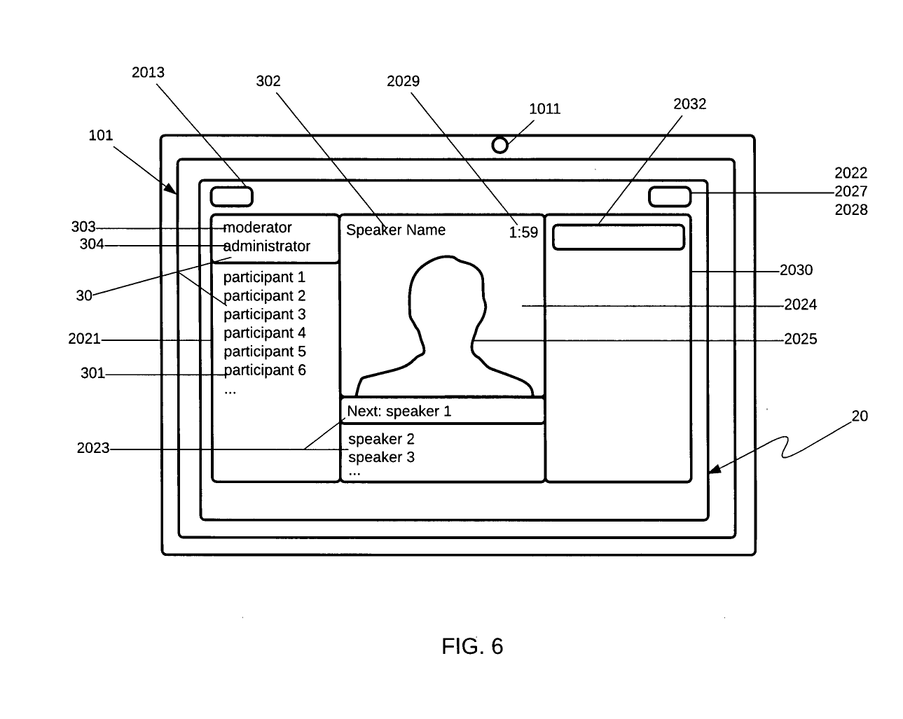

FIG. 6 is a mobile tablet screen image showing the speaker's image; the participants in the speakers' queue; the names of the administrators, moderators, and participants; and the text chat screen.

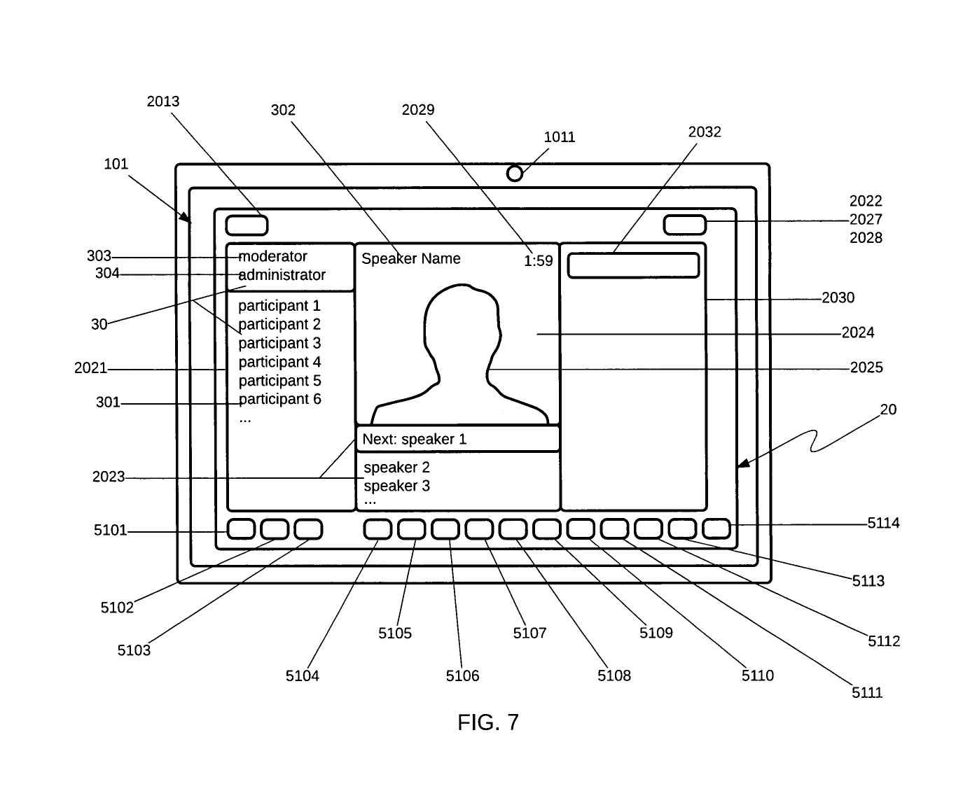

FIG. 7 is a mobile tablet screen image of the moderator's screen showing the speaker's image; the participants in the speakers' queue; the names of the administrators, moderators, and participants; the text chat screen; and the administrator's control buttons.

### REFERENCE NUMERALS IN DRAWINGS

10—Mobile Communication Device
101—Screen
1011—Camera
102—Keypad
103—Microphone
104—Embedded speaker (not shown)
104D—Detached speaker (not shown)
105—Search button
106—Favorites button
107—About button
108—Site button
109—Links button
110—Blogs button
11—Server
12—Data stream
20—Virtual Meeting Room
201—Room name input field
201B—Screen name input field
2011—Visit lounge button
2012—Enter room button
2013—Return to lobby button
202E—Lounge
202L—Virtual lobby
202R—Meeting room
2021—Participants screen
2022—Ask to speak button
2023—Speaker's queue
2024—Speaker's box
2025—Speaker's image
2026—Moderator's image
2027—Leave queue button
2028—Stop speaking toggle
2029—Countdown clock
2030—Text chat window
2031—Show text chat button
2032—Text chat typing field
2033—Raise hand button
2034—Participants button
2035—Send chat button
30—Virtual Meeting Attendees
301—Participant
302—Speaker
303—Moderator
304—Administrator
305—Observer
306—Texter
40—Participation Functions
401—Enter room function
402—Ask to speak function
403—Enter speakers' queue function
404—Leave speakers' queue function
405—Enter speakers' box function
406—Leave speakers' box function
407—Start speaking function
408—Stop Speaking Function
409—Text message function
4010—Raise-hand function
4011—Send text message function
50—Control/Moderating Functions
501—Display visual aid function
502—Remove Visual Aid Function
503—Assign order of speakers' function
504—Establish speaking time function
505—Reset/modify speaking time function
506—Mute participant(s) function
507—Eject participant function
508—Control speaker's volume function
509—Enable hand-polling function
5010—Interruption function
5011—Speaker replacement function
5012—Speakers' queue advancement function
5013—Asset display function
5014—Text chat disable function
5015—Private text chat function
51—Control/Moderating Buttons
5101—Open side chat with administrator button
5102—Mute user button
5103—Eject user button
5104—Raise hand button
5105—Adjust speaker volume button
5106—Speak next button
5107—Interrupt current speaker button
5108—Interrupt and remove current speaker button
5109—Rotate/skip to next speaker in line button
5110—Assets folder
5111—Close assets folder button
5112—Disable text chat button
5113—Show cursor button
5114—Start/stop recording button

### DETAILED DESCRIPTION

### Description

### Preferred Embodiment

Referring to FIGS. 2A and 2B, the process begins when the user downloads and installs the present invention on his/her mobile communication device (10) such as, without limitation, a tablet as depicted in FIG. 2A or mobile phone as depicted in FIG. 2B. Conceivably, the present invention would be compatible and downloadable into future generations of the aforementioned mobile communications devices (10). The mobile communication device (10) will typically have a screen (101) with a camera (1011) embedded in or attached thereto, a keypad (102), which could be used for sending text messages and a microphone (103) embedded or attached thereto. The keypad (102) would typically be found on the screen (101) of a mobile phone where the user engages in text messaging. The key pad (102) could be a separate component that is physically separated from the screen (101) as it would be on a personal computer ensemble. On the other hand, the keyboard (102) might be connected to the screen as it would on a tablet as shown in FIG. 2A. Here, the keyboard (102) is physically attached to the screen (101) by a hinged connection thereby making it the bottom half of the foldable mobile communication device (10).

Once the present invention has been downloaded and installed in the user's mobile communications device (10), that user can use the present invention to host his/her own virtual meeting or join a virtual meeting hosted by another user that has similarly downloaded and installed the present invention on its mobile communication device (10). Referring to FIG. 2C, the users, or as they are referred to in this description of the invention, the virtual meeting attendees (30), use their respective mobile communication devices (10) to connect to a virtual meeting room (20) through a server (11). The owner or host of the virtual meeting room (20) has used the present invention, which is an application that he/she has downloaded onto his/her personal communication device (10) to establish the virtual meeting room (20) on the Internet through its server (11). To participate in this virtual meeting hosted by another party, the user goes to the screen (101) on his/her mobile communication device (10) where, on the appropriate screen (101) called up that device (10), enters the name that would connect the attendee (30) to the host or sponsor's virtual meeting room (20). When the first user connects to the screen containing the host or sponsor's virtual meeting room (20), a data stream (12) is opened on the server (11) that is supporting that virtual meeting room (20). The data stream (12), which transmits audio, video and text messages among the attendees (30), remains open and active until the last attendee (30) disconnects from that virtual meeting room (20).

The present invention contemplates several different types of attendees (30). Participants (301) are attendees (30) who participate in a virtual meeting in one capacity or another. Speakers (302) are participants (301) who engage in speaking during the virtual meeting; when they are finished speaking, they revert to being participants (301). The moderator (303) is a participant (301) tasked with monitoring and controlling the virtual meeting. An administrator (304) is tasked with various administrative and engineering tasks related to the running of the virtual meeting. The roles of moderator (303) and administrator (304) are fixed through the duration of the virtual meeting but either can be a speaker (302) or a texter (306) while still maintaining their role and functions as moderator (303) or administrator (304). An observer (305) is a participant (301) who merely observes the events of the virtual meeting without actively participating therein. A texter (306) is a participant (301) who engages in text message communication with the moderator (303) or another participant (301); when he/she has finished his/her text communication, he/she reverts to being a participant (301).

During a typical virtual meeting on a mobile communication device (10) such as a mobile phone or a tablet, any one of several “events” occurs which give meaning and purpose to that particular virtual meeting. Such events include, without limitation: (1) Someone speaks; (2) Someone is or becomes visible on a camera interfacing with the Internet (using the built-in mobile device camera); (3) Someone displays an image or video to the other participants; (4) Someone enters or leaves the meeting; (5) Someone sends a text message to one or more attendees; and (6) Someone sends a file to one or more participants. While existing rules of on-line meeting etiquette offer some degree of control over such a meeting, the tendency to interrupt or otherwise interfere with an ongoing dialogue or exchange is always present and when acted upon could lead to competing participants (301) drowning each other out. As the number of participants (301) increases, the likelihood of such an occurrence increases accordingly.

The present invention addresses that problem directly and thereby brings the virtual meeting to the next level by (1) allowing the user to perform or execute all of these events on a mobile communication device (10) such as a mobile phone or a tablet (as opposed to a stationary audio video ensemble located in a fixed location) and (2) allowing a designated participant (301), the moderator (303) to more effectively moderate or control the virtual meeting by limiting the number of speakers (302) to one-at-a-time, determining the order of speakers (302), limiting the amount of time each speaker (302) has, and permitting all participants (301) to simultaneously send text messages to other participants (301) as texters (306) while a given participant (301) is speaking.

If a virtual meeting is being conducted on a mobile device, desktop computer, laptop or notebook computer without the present invention installed, the same interference problems are likely to occur as multiple participants (301) attempt to engage in these meeting activities (speaking, texting, showing visual clues, and the like) at the same time and they tend to interfere with one another; in the case of speaking, they drown each other out. The present invention provides an orderly method of conducting a remote on-line virtual meeting such as a banking tutorial, videoconference, discussion, presentation, classroom lecture, demonstration, remote news report, shareholders meeting, and other such social gatherings. It serves to control the meeting by regulating who is speaking at any given time. It provides a means of limiting the speaking function to one speaker (302) at a time and establishing an order of presentations by successive speakers (302). It provides a means for limiting the amount of time allocated to each speaker (302) and increasing that time limit while the speaker (302) is actually speaking. It provides participants (301) with a means of communicating by text message with the speaker (302), the moderator (303), any other participant (301), or all other participants (301) while the speaker (302) is speaking.

Referring now to the following figures, the present invention provides these means through a virtual meeting room (20) having keying features that allow the participants (301) to execute a series of discrete functions in order to more effectively participate in the virtual meeting. FIG. 3A shows a mobile communication device (10) which, in this case, is a mobile phone having standard features such as a screen (101) with a camera (1011) embedded or attached thereto, a keypad (102) for sending text messages, a microphone (103) for transmitting verbal messages, and an embedded speaker (104) for receiving verbal messages. The embedded speaker (104) is not shown since it is typically embedded in the device (10) itself. Similarly on a mobile phone mobile communication device (10), the microphone (103) may also be embedded in the device (10).

The screen (101) display depicted in FIG. 3A shows the presentation after the participant (301) has activated the application containing the present invention. At this point, the participant is deciding which room he/she wishes to visit. The three buttons shown near the top of the screen (101) in FIG. 3A are typical features found with applications such as the present invention. The search button (105) allows the participant (301) to type in the room name he/she wishes to join in his/her mobile communications device (10). The favorites button (106) allows the participant (301) to easily access rooms he/she has previously visited. The about button (107) allows the participant (301) to retrieve information regarding the operation of the present invention as well as information regarding products and services related to the present invention.

The room name input field (201) allows the participant (301) to type in the room name of the virtual meeting room (20) he/she desires to attend. The visit lounge button (2011) allows the participant (301) to enter the lounge (202E) which is a demo room for testing and familiarization (not shown) if the participant (301) does not have a designated room to visit.

FIG. 3B gives a screen (101) depiction of what the participant (301) sees upon entering the virtual lobby (202L) which is virtually outside of the meeting room (202R). While in the lobby (202L), the participant (301) can prepare himself/herself for events taking place inside the meeting room (202R). The three buttons seen near the top of the screen (101) allow the participant (301) to access real-time and background information about the events taking place in the meeting room (202R). The Site button (108) provides the participant (301) with information about the meeting room (202R). The links button (109) provides the participant (301) with hyperlinks to websites that are pertinent to the events taking place inside the meeting room (202R). The blogs button (110) provides the participant (301) with a list of blog articles that are pertinent to the events taking place inside the meeting room (202R). Immediately underneath these three buttons (108), (109), and (110), the participant (301) sees a screen name entry field (201B) where the participant (301) would enter a screen name for identification purposes. Next to the screen name entry field (201B) there is an enter room button (2012) that when pressed, places the participant inside the meeting room (202R). When ready to enter the meeting room (202R), the participant (301) types or texts his/her screen name into the screen name entry field (201B). The “enter room” button (2012) allows the participant (301) to move out of the lobby (202L) and into the meeting room (202R).

Referring now to FIG. 4A, we see the screen (101) image seen by the participant (301) once he/she has entered the meeting room (202R) where the unique features of the present invention permit the participant (301) to more effectively participate in the virtual meeting. These features include improvements such as the “ask to speak” button (2022) which, when touched, signals a participant's (301) desire to participate in the virtual meeting as a speaker (302). Pressing the “ask to speak button” (2022) places the participant (301) in a speaker's queue (2023) which is a virtual “waiting line” for speakers (302) who will be electronically placed in a speaker's box (2024) when it is that speaker's turn to speak.

While the participant (301) is waiting in the queue (2023) for his/her turn to speak, the “ask to speak” button (2022) will change text to read “leave queue” (2027) and when pressed will remove the participant (301) from the waiting queue (2023). When it is time for that participant (301) to speak, the “ask to speak” button (2022)is electronically converted to a stop speaking toggle (2028) which the speaker (302) toggles when he/she finishes speaking. The stop speaking toggle (2028) is then electronically converted back to an “ask to speak” button (2022). As will be discussed more thoroughly below, these features represent a significant improvement over the devices taught by the prior art in that they greatly assist in maintaining order during the virtual meeting by aiding in the control over who is speaking and how long they are speaking. To the left of the “ask to speak” button (2022)/leave queue toggle (2027)/stop speaking toggle (2028) is the return to lobby button (2013) which allows any participant to return to the lobby (202L) at any time during the virtual meeting.

Another feature of the present invention seen in FIG. 4A is the speakers' box (2024) where only one virtual meeting participant (301), the speaker (302), can speak at a time. The speaker's box (2024) displays a speaker's image (2025) which is a live video feed of the speaker (302) while he or she is speaking. In the upper left-hand corner of the speaker's box (2024), the name of the speaker (302) is displayed to allow participants (301) to easily identify the speaker (302). In the upper right-hand side of the speaker's box, the countdown clock (2029) displays the amount of time the current speaker (302) has left before the next speaker (302) enters the speaker's box (2024). Immediately below the speaker's box (2024) is the text chat window (2030) which displays text messages posted by participants (301). Below the text chat window is the Text Chat button (2031) and Participants button (2034) which allow the participant (301) to change views of the text chat window (2030) to a list of the participants in the room (2021) and back to text chat. The text chat typing field (2032) is within the text chat window (2030); it displays an outgoing text message being prepared for sending by a texter (306). The texter will use the device's (10) keyboard (102) and upon pressing “Done” or closing the keyboard (102) screen, the text will be sent to all participants (301). As mentioned previously, this ability to send text messages while a speaker (302) is talking represents a significant improvement over the devices taught by the prior art in that it eliminates the “drowning out” of speakers (302) and replaces it with an orderly flow of text messages prepared and sent while the speaker (302) is still talking. The mobile communication device (10) will also deliver a live audio feed to the device's (10) embedded speaker (104) so that the participant can hear what the speaker (302) is saying.

In the event that the moderator (303) desires to poll the participants (301) by a show of hands, a raise hand button (2033) will appear on the screen in the text chat window (2030) thereby allowing the participant (301) to signal his/her vote by pressing the raise hand button (2033) at the appropriate time. In the event the participant (301) desires to see a list of other participants (301), the “Participants button” (2034) gives that participant (301) access to a list of all participants (301) who are in the meeting room (202R).

FIG. 4B shows the screen (101) after the participant (301) has pressed the “Participants button” (2034). Immediately below the speaker's image (2025) is the participants screen (2021) which now lists all of the participants (301) in the meeting room (202R). Should the participant (301) wish to return to the previous screen (101) images showing text messages, he/she need merely press the show text chat button (2031) which will return the participant (301) to the screen (101) image shown in FIG. 4A.

FIG. 5 shows the screen (101) of a mobile communication device (10) with a larger screen (101) which, in this case, is the screen (101) of a tablet. The screen (101) depicts what the participant would see upon entering the meeting room (202R). For mobile communication devices (10) of this type, the “buttons” on the screen (101) can be pressed using a mouse or, if this device (10) has a touch screen capability, by actually pressing the button image with the participant's finger.

The process for getting to the meeting room (202R) shown in FIG. 5 would be the same as it was for the mobile phone application. After the participant (301) has activated the application containing the present invention, his/her computer screen (101) would show a display similar to the screen (101) seen in FIG. 3A. The tablet application also gives the participant three buttons (not shown in FIG. 5) that perform the same functions as those on the mobile phone application. A search button (105) allows the participant (301) to type into a text box (similar to the room name input field (201) shown in FIG. 3A) the name of the room (202R) he/she wishes to enter on his/her mobile communication device (10). The favorites button (106) allows the participant (301) to retrieve a list of rooms recently visited for easier access on a return visit. The about button (107) allows the participant (301) to retrieve information regarding the operation of the present invention as well as information regarding products and services related to the present invention.

Prior to getting to the meeting room (202R) shown in FIG. 5, the participant (301) using a tablet device (10) would view a screen (101) that is similar to the screen (101) depicted in FIG. 3A. The tablet screen (101) display would also have a room name input field (201) that allows the participant (301) to type in the room name of the virtual meeting room (20) he/she desires to attend. It would also have a visit lounge button (2011) which allows the participant (301) to enter the (virtual) lounge (202E) which is a test room for those participants (301) who do not have an existing room. Similar to the mobile phone screen (101) depicted in FIG. 3B, the participant's (301) tablet screen (101) would reflect what the participant (301) sees upon entering the virtual lobby (202L) which is virtually outside of the meeting room (202R). While in the lobby (202L), the participant (301) can prepare himself/herself for events taking place inside the meeting room (202R). Unlike the screen (101) depicted in FIG. 3B, all information accessed by the three buttons (108), (109), and (110) would be available on a single screen (101) thereby allowing the participant (301) to access real-time and background information about the events taking place in the meeting room (202R). This lobby (202L) is slightly different than that found in the smaller mobile phone device (10) in that the information accessed by pressing the links button (109) or the blogs button (110) on the mobile phone device (10) would already be displayed on the larger screen (101).

The computer screen (101) depicted in FIG. 5 shows that a great deal more is offered at once to the participant (301) upon entering the meeting room (202R) because of the larger size of the screen (101) of a tablet as opposed to that of a mobile phone. Accordingly, once the participant enters the meeting room (202R), he or she has immediate visual access to the participants screen (2021), the speaker's queue (2024), the speaker's box (2024), and the text chat window (2030) features of the present invention. Specifically, upon entering the meeting room (202R), the present invention provides the participant with a participants screen (2021) which gives the participant (301) a complete list of all participants (301) currently in the meeting room (202R) as well as the names of the moderator (303) and the administrator (304) as appropriate. Since not all virtual meetings utilize or have need for a moderator (303) and/or administrator (304), the names of these specially tasked individuals will appear only when they are actually participating. Simultaneously, the participant (301) will see the speaker's box (2024) showing a live video feed of the current speaker—the speaker's image (2025), the current speaker's name, and the countdown clock (2029) which shows how much time the current speaker (302) has left in the speaker's box (2024). The mobile communication device (10) will also deliver a live audio feed to the device's (10) embedded speaker (104) or a detached speaker (104D) as the case may be. In the event that the moderator (303) interrupts the speaker (302) or otherwise addresses the participants (301), the moderator's image (2026) will appear in the speaker's box (2024).

Directly beneath the speaker's box (2024) is the speaker's queue (2023) which shows the speakers (302) waiting in line to enter the speaker's box (2024). Specifically, the speaker's queue (2023) identifies the next speaker (302) and, in ascending order, the names of the speakers (302) waiting in line behind the next speaker (302). As with the mobile communication device (10) depicted in FIGS. 4A and 4B, the device (10) depicted in FIG. 5 also has an “ask to speak” button (2022) co-located with the leave queue button (2027) and the stop speaking toggle (28).

When pressed, the “ask to speak” button (2022) signals a participant's (301) desire to participate in the virtual meeting as a speaker (302). Pressing the “ask to speak button” (2022) places the participant (301) in a speaker's queue (2023) which is a virtual “waiting line” for speakers (302) who will be electronically placed in a speaker's box (2024) when it is that speaker's (302) turn to speak. When it is time for that participant (301) to speak, the “ask to speak” button (2022) is electronically converted to a stop speaking toggle (2028) which the speaker (302) toggles when he/she finishes speaking. The stop speaking toggle (2028) is then electronically converted back to an “ask to speak” button (2022).

To the right of the speaker's box (2024) and the speaker's queue (2023), the participant (301) would see the text chat window (2030) which would display text messages posted by other participants (301). Should a participant (301) desire to send a private text message to the moderator (303) or administrator (304), he/she can initiate such a communication by pressing the open side chat with administrator button (5101).

Pressing either of these buttons (2031), (5101) also activates the text chat typing field (2032) as depicted in FIG. 6. The text chat typing field ((2032) displays any text message the participant (301) is preparing to send. When the participant is ready to send his/her text message, he/she presses the send chat button (2035) which sends the text message to the designated participants (301), (303), or (304). When the participant (301) is communicating with the moderator (303) or administrator (304), pressing the send chat button (2035) sends the text message to the moderator (303) or administrator (304) but not to any of the other participants (301). Any replies from the recipient (301), (303), or (304) will appear in the text chat window (2030). On a tablet device (10), the soft keyboard/keypad (102) would appear and when closing it or pressing “Done” on the keyboard/keypad (102), the message is sent.

As mentioned previously, the present invention represents a major improvement in virtual meeting room communications because of the inherent control and moderating capabilities contained therein. To maintain an orderly flow of speakers speaking one at a time and to prevent interruptions, confusion, and “hogging the mike,” the moderator (303) has a series of tools to help him/her maintain order in the meeting room (202R). FIG. 6 shows the meeting room (202R) as seen on the screen (101) on the moderator's mobile communication device (10). This screen (101) would be similar for either type of device (10) discussed (mobile phone or tablet).

The screen (101) viewed by the moderator (303) contains the same features available to participants (301) such as the participants screen (2021) which provides a list of the participants (301), moderator (303), and administrator (304) in the meeting room (202R): the speakers box (2024) showing the speaker's image (2025) and the countdown clock (2029); the speakers queue (2023) showing the names and order of speakers (302) waiting to speak; and the text chat window (2030) with its text chat typing field (2032) to ensure that the moderator (303) is seeing the same activity in the meeting room (202R) that the participants (301) are seeing. However, to maintain order in the meeting room (202R) the moderator has a series of control/moderating buttons (51) to assist him/her in that function. The screen (101) seen by the moderator (303) like that of the mobile phone and computer screens (101) has standard features of a camera (1011), keypad (102)(not shown on FIG. 6), microphone (103) and an embedded speaker (104) or a detached speaker (104D) as appropriate.

The open private chat button (5101) allows the moderator (303) to open a private text communication dialogue with any participant (301) the contents of which remain between the moderator (303) and the selected participant (301). The mute user button (5102) is a toggle control that when pressed, mutes the selected participant (301); pressing this button/toggle (5102) again will restore the sound to the selected participant (301). The eject user button (5103) allows the moderator (303) to remove an uncooperative or disruptive participant (301) from the meeting room (202R) by immediately severing that participant's connection to the meeting room (202R) site. The raise hand button (5104), also known as the “enable poll” button allows the moderator (303) to query the participants (301) on a particular matter. Pressing this button (5104) will allow the moderator (303) to send a text message to all participants (301) asking for a vote on a particular issue. Pressing this button (5104) also activates the raise hand button (2033) on each participant's (301) screen (101) and allows each participant (301) to vote yes or know by pressing their respective raise hand button (2033).

The adjust speaker volume button (5105) allows the moderator (303) to adjust the volume of the audio stream coming from the speaker's (302) microphone (103). The “speak next” button (5106) allows the moderator enter a participant (301) into the speaker's queue (2023) at the front of the line and be “Next” in line in the speaker's queue (2023). The interrupt current speaker button (5107) allows the moderator to interrupt the current speaker (302) by placing the moderator (302) in the speaker's box (2024) to address the meeting room (202R). The current speaker (302) is moved down into the “Next” position and will automatically return to the Speakers Box (2024) when the moderator (303) has finished speaking. The interrupt and remove current speaker button (5108) takes this effort one step further and removes the current speaker (302) from the speaker's box (2024) and the speaker's queue (2023) altogether. The rotate/skip to next speaker button (5109) allows the moderator (303) to remove the current speaker (302) and advance the remaining speakers (302) in the speaker's queue (2023). The assets folder button (5110) allows the moderator (302) to access the assets (visual aids, charts, diagrams, videos etc.) folder made available to the meeting room (202R) and display them on the screen (101) above the room view for participants' (301) viewing. The close assets folder button (5111) closes the assets folder. The disable text chat button (5112) allows the moderator (303) to disable the text message function (409) for the entire meeting room (202R). The show cursor button (5113) allows the moderator (302) to show his/her cursor on the screens (101) seen by the participants (301). The start/stop recording button (5114) allows the moderator (303) to record the activities taking place in the meeting room (202R) using the device's (10) internal recording features.

These control/moderating buttons (51) give the moderator (303) a large array of tools to maintain order and control of the activities in the meeting room. They preclude participants (301) from interrupting each other, taking more than their fair share of time speaking, and drowning each other out. They allow the moderator to interrupt speakers (302) for any number of administrative reasons and ultimately eject uncooperative, combative, insulting, or vulgar participants (301). They allow the moderator (302) to modify the order of speakers (302) and provide additional time to speakers (302) if the moderator feels such is warranted. Given that the present invention can accommodate several hundred participants (301), these controls are essential.

As mentioned above, the one-speaker-at-a-time feature and the speakers' queue (2023) function provide the present invention with a capability to host video conferences with significantly larger numbers of participants (301) than other videoconferencing applications hosted on a mobile communications device (10) such as a mobile phone or tablet. Referring again to FIGS. 1A, 1B, 1C, and 1D during a videoconference or virtual meeting conducted on a desk-top or lap-top computer using other videoconferencing applications found in the prior art, it is possible to see the faces of several or all participants on the computer screen at the same time. It is also possible to have all of the participants connected at the same time. This allows them some visual clue as when a participant wishes to speak. Accordingly, in a videoconference or virtual meeting with twenty participants, each participant can see the other participants and observe some type of visual data (signal, waving a hand, flashing a light, etc.) that a particular participant wishes to speak. However, as shown in FIGS. 1B and 1D, this visual display becomes unwieldy upon reaching a certain critical number of participants because the images are truncated as shown in FIG. 1B or become too small as shown in FIG. 1D. Further, since all participants are connected at the same time, the problem of multiple speakers trying to speak or actually speaking at the same time reappears if the visual clues are missed or ignored. Further still, latency of the receiving transmission can provide false visual queuing for normal dialogue when multiple video participants are connected simultaneously.

The present invention recognizes the size limitations of the screen on a mobile communication device and the size limitations faced by computer screens associated with tablets. While it may be possible to display the images of twenty participants on computer screens associated with desktop computers or lap-top computers, displaying that many images would be space-limited on a computer tablet screen and not feasible on the much smaller screen associated with a mobile phone. For numbers above twenty or so participants, the limits of screen size take over and the images typically become too small to display on any of the screens. The present invention uses the one-speaker-at-a-time feature and the speakers' queue function (2023) to address this limitation as well. The one-speaker-at-a-time feature limits the screen (101) display to the speaker (302) or the moderator (303). As seen in FIGS. 4A, 4B, 5, and 6, all of the participants (301) in the virtual meeting room (20) can see the speaker (302) or the moderator (303) but they cannot see any of the other participants (301) unless that participant (301) becomes the speaker (302). They can, however, see a list of participants (301). When the speaker (302) has finished talking, the next participant (301) in line in the speakers queue (2023) as depicted on the screen (101) will advance to the currently speaking position, i.e., the speakers' box (2024) where it will remain until he/she has finished speaking or until their time to speak has expired.

As another feature of the present invention, the participants (301) can also place text messages and comments in a separate space on the screen (101); this feature is referred to as the text chat window (2030) as seen on the lower half of FIG. 4A and to the right of the speaker's box (2024) on FIGS. 5 and 6. This permits non-speaking participants (301) to post text messages and/or comments and questions while the speaker (302) is talking.

This system for conducting an online virtual meeting using mobile communication devices (10) is embedded in a computer program that can be downloaded as an accessory application or initially installed on any commercially available mobile phones or computer tablets. The application allows the user to create his/her own virtual meeting room (20) or enter into a virtual meeting room (20) hosted by another party; both meetings would be governed by the functions inherent in the present invention.

Referring again to FIG. 3A, the present invention contemplates a virtual meeting room (20) having an room name input field (201). The room name input field (201) provides virtual meeting attendees (30) with simple instructions on how to enter the meeting room (202R) or lounge (202E) [which, as mentioned previously, is a demonstration room for participants (301) who have not yet selected a meeting room (202R)]. Once inside the meeting room (202R), attendees (30) will have access to the features contemplated by the present invention. The participant's screen (2021) shown in FIGS. 4B, 5-7, lists the screen name of every participant (301) in the meeting room (202R). If a moderator (303) or administrator (304) is participating, their names will appear on the participants' (301) screen (2021) as well. As seen in the upper right-hand corner of FIGS. 4B, 6 and 7, the ask-to-speak button (2022) signals the participant's (301) desire to speak and when pressed, using touch screen technology like all of the “buttons” found in the present invention, will automatically and electronically place the screen name of the requesting participant (301) in the speakers' queue (2023). As with all “buttons” found in the present invention, pointing and clicking the mobile device's mouse or stylus will also send the same signal generated by actually touching the screen (101) with a finger. The names of the participants (301) in the speakers' queue (2023) are electronically arranged in the order received so that when the speaker (302) in the speakers' box (2024) is finished speaking, the participant (301) at the top of the list in the speakers' queue (2023) will automatically and electronically be moved into the speakers' box (2024). As seen in FIGS. 4A, 4B, 5, 6, and 7, the speakers' image (2025), which is transmitted electronically from the speaker's (302) camera (1011), and the screen (101) name of the departing speaker (302) will be removed from the screen (101). The incoming speakers' image (2025), transmitted electronically from that speaker's (302) camera (1011) and the screen name of the incoming speaker (302) will now be displayed on the screen (101). If a moderator (303) is participating and the moderator (303) is speaking, the moderator's image (2026), transmitted electronically from the moderator's (303) camera (1011), and his/her screen name will be displayed on the screen (101).

When the next speaker's (302) turn to speak has arrived, he/she will be automatically and electronically moved out of the speakers' queue (2023) and into the speaker's box (2024). If a participant (301) signals his/her desire to speak by using the ask-to-speak button (2022) and there is no participant (301) in front of him/her in the speakers' queue (2023) and the speaker's box (2024) is not occupied, that participant (301) will be automatically and electronically moved into the speaker's box (2024). Once the speaker (302) enters the speaker's box (2024), his/her microphone (103) is immediately and electronically activated as is countdown clock (2029); the speaker (302) simply begins speaking and continues to do so until he/she runs out of time. When the speaker (302) has finished speaking prior to the end of his/her allotted time, he/she will simply press the (touch screen) stop speaking toggle (2028) which will cause him/her to be automatically and electronically removed from the speaker's box (2024). In the event where the allotted time for speaking elapses while the speaker (302) is still speaking, that speaker (302) will automatically and electronically be removed from the speaker's box (2024) and the next speaker (301) in the speakers' queue (2023) will automatically and electronically be moved into the speakers' box (2024). The time allotted for each speaker (302) is pre-determined and the speaker (302) has some sort of countdown clock (2029) on his/her screen (101) to advise them of how much time is remaining. Finally, the moderator (303) or administrator (304) may reset the countdown clock (2029) and thereby allow the speaker (302) to continue speaking in the speaker's box (2024).

Referring again to FIGS. 4A, and 5-7, some additional features of the meeting room (202R) include a text chat window (2029) which is part of a split-screen display on the screen (101) showing the speakers image (2025) on one part of the screen (101) and the text chat window (2029) which is a running dialogue of text messages from participants (301) on another part of the screen (101). The (touch screen) raise hand button (2031) allows participants (301) to vote or be counted in a polling survey initiated by the moderator (303).

### Operation

### Preferred Embodiment

The operation of the preferred embodiment of the present invention in establishing and conducting a virtual meeting using mobile communications devices involves a series of interrelated steps. The present invention's has role-based functions applicable to the participant (301) which are referred to as the “participation functions” (40). The enter room function (401) is accomplished electronically when the participant (301) presses the enter room button (2012) using either touch-screen technology or the mouse on his/her mobile communication device (10).

FIG. 3A shows the Room name input field (201). Upon providing the name of the room to enter, the Participant (301) is moved electronically to the meeting room's (202R) lobby (202L), which is depicted in FIG. 3B. Alternatively, by pressing the ‘Visit Lounge’ button (2011), the participant's (301) choice of rooms is set to the default test room referred to as “the Lounge (202E).” Referring again to FIG. 3B, from this “lobby screen (101),” the user then types their screen name into the screen name input field (201B). The enter room function (401) is then accomplished electronically from the “lobby screen (101)” when the participant (301) presses the enter room button (2012) using either touch-screen technology or the mouse on his/her mobile communication device (10). At this point, the participant (301) has been electronically transported from the lobby (202L) to the meeting room (202R) shown in FIGS. 4A and 4B.

Once inside the meeting room (202R), the participant (301) can begin his/her collaboration with other participants (301). The participant (301) can visually check the participants screen (2021) to see who the other participants (301) are. The participant (301) can send a text message to any other participant (301) by typing the message on his/her keypad (102) and then electronically transmitting it to the other participants (301) by activating his/her device's (10) cursor or touching the (touch screen) send chat button (2031). If the participant (301) wishes to speak to the other participants (301) he presses or clicks the ask-to-speak button (2022) which automatically and electronically triggers the ask-to-speak function (402). The ask-to-speak function (402) places the participant's (301) screen name in the speaker's queue (2023); this may also be referred to as the enter speakers' queue function (403). The screen names of participants (301) are automatically and electronically placed in the speakers' queue (2023) in chronological order so that the earliest participant (301) requesting to speak will be at the top of the list in the speakers' queue (2023).

When a participant's (301) turn to speak comes up, he/she becomes a speaker (302) and the present invention triggers the leave speakers' queue function (404) and the enter speaker's box function (405) simultaneously. It will also post the speakers image (2025) of the incoming speaker (302) on the screen (101) viewed by all other participants (301). The incoming speaker's (302) turn to speak will come up when the current speaker (302) presses or clicks the stop speaking button (2028) or when he/she runs out of time. Both instances will electronically trigger the leave speakers' box function (406).

The present invention automatically and electronically executes the start speaking function (407) when the speaker (302) enters the speaker's box (2024) by activating the speaker's (302) microphone (103) and the countdown clock seen on all participants' (301) screens (101). The start speaking function (407) can also be executed manually by the moderator (303) or administrator (304) by interrupting or stopping a speaker (302) or placing the next speaker (302) into the speaker's box (2024). Once the new speaker (302) has been placed in the speaker's box (2024) by the moderator (303) or administrator (304), the start speaking function (407) is again automatically executed by activating the speaker's (302) microphone (103) and the countdown clock seen on all participants' (301) screens (101). As mentioned previously, the countdown clock (2029) keeps track of the amount of time the speaker (302) has been speaking and notifies the speaker (302) and other participants (301) how much time the speaker (302) has remaining before he/she is removed from the speaker's box (2024). To begin speaking, the speaker (302) simply looks into the camera (1011) and begins speaking into the microphone (103). It is important to note that this sequence of events positively limits the number of speakers (302) to one at a time. The only participant (301) who can be speaking at any given time is the participant (301) who is in the speaker's box (2024), i.e., the speaker (302), and the present invention limits the number of people in the speaker's box (2024) to one at a time. If a moderator (303) or administrator (304) interrupts a speaker (302), that speaker's (302) audio transmission is temporarily terminated and only the moderator (303) or moderator's (304) voice will be heard. This one-speaker-at-a-time feature represents a significant improvement over videoconferencing devices found in the prior art because videoconferencing on the devices found in the prior art could quickly become chaotic in the event of multiple parties speaking at the same time.

When the speaker (302) has finished speaking or when the allotted time has expired, the stop speaking function (408) will be executed by the speaker (302) pressing or clicking the stop speaking toggle (2028) or, in the event that the speaker (302) has used up all of the allotted time, the present invention will automatically terminate the speaking session. In both, instances, the above-mentioned sequence of events is repeated. The next participant (301) in the speakers queue (2023) will automatically and electronically be moved into the speakers' box (2024) and the speakers' image (2025) of that incoming speaker will be posted on the screen (101).

All participants (301) can execute the text message function (409), the raise-hand function (4010) [if the moderator (303) or administrator (304) enables the raise-hand function (4010) with a polling query using the enable hand-polling function (509)], and the send text message function (4011). The send text message function (4011) contemplates sending “text-chat” messages to a speaker (302) and the other participants (301), asking for administrative support from the Moderator (303) or the Administrator (304), and sending private “text-chat” messages to the Moderator (303). The raise hand function (4010) contemplates the participant (301) “raising his/her hand” by pushing or clicking the (touch screen) raise hand button (2030) in response to the Moderator's (303) call for a vote on a particular item.

The present invention contemplates the orderly conduct of a virtual meeting or videoconference through the proper functioning of the speakers' queue (2023) and the one-speaker-at-time design feature. Once the virtual meeting or videoconference has begun, the automatic and ongoing operation of the foregoing features typically keeps the virtual meeting or videoconference on track and on schedule. However, there may be occasions when the host desires to have one participant (301) assume responsibility for exercising more direct and interactive control over the virtual meeting or videoconference by assuming the role of moderator (303) or administrator (304). In these instances, the moderator (303) or administrator (304) monitors the conduct of the virtual meeting or videoconference and intervenes as necessary to bring or keep the participants′(301) comments in line with the purpose of the virtual meeting or videoconference, to remove an uncooperative or vulgar speaker (302), to give more speaking time to a speaker (302) whose time has expired, to interrupt a speaker (302) to clarify a point or statement, to initiate a poll amongst the participants (301), to post or otherwise display visual or graphic aids, and other such administrative or moderating tasks. To accomplish these tasks, the present invention provides several role-based functions applicable exclusively to the moderator (303) or administrator (304). These include the following control/moderating functions (50).

The Display Visual Aid Function (501) and the Remove Visual Aid Function (502) allow the moderator (303), administrator (304), or speaker (302) to upload, display, and remove visual aids such as images, graphs, slides, and the like while using a laptop or tablet computer to conduct the videoconference. Referring again to FIG. 7, to upload images, the moderator (303) or administrator (304) simply touches or clicks the assets folder button (5110) on the screen (101) used by the moderator (303) or administrator (304) to browse the images stored on his/her hard drive. When the desired image is located, the moderator (303) or administrator (304) would then upload them for display on the screen (101). To upload Power Point® slides, the moderator (303) or administrator (304) would have to save the slides in JPEG format and then upload them for display on their respective screens (101).

While the present invention automatically limits the time a speaker (302) has to speak while in the speaker's box (2024) to a predetermined maximum, the moderator (303) or administrator (304) may wish to increase or decrease that predetermined maximum or afford a particular speaker (302) more than the predetermined maximum amount of time. The moderator (303) or administrator (304) accomplishes this task using the establish-speaking-time function (504) or the reset/modify speaking time function (505). The moderator (303) or administrator (304) accomplishes these tasks by simply touching or clicking on the drop-down arrow to the right of the countdown clock (2029) on the moderator's (303) or administrator's (304) screen (101) and then entering the desired amount of time to be allocated to the speaker (302).

There may be occasions where the moderator (303) or administrator (304) wishes to adjust the speaker's (302) volume, to interrupt a speaker (302), or to eject a speaker (302) or unruly participant (301) from the videoconference. To accomplish these tasks, the moderator (303) and administrator (304) are equipped with a mute participant(s) function (506), an eject participant function (507), a control speaker's volume function (508), and an interruption function (5010). Referring again to FIG. 7, the moderator (303) and administrator (304) have a screen (101) configuration that is slightly different from that available to each participant (301). As seen in FIG. 7, the screen (101) used by the moderator (303) or administrator (304) has additional buttons that allow them to execute the foregoing functions. This screen (101) also has the raise hand button (5104) that engages the enable hand-polling function (509) which permits the moderator (303) or administrator (304) to query or take a poll among participants (301). The participants (301) would respond to the poll request by touching or clicking their respective raise hand buttons (2031) with the appropriate response to the polling query.

The present invention automatically and electronically removes a speaker (302) from the speaker's box (2024) when his/her allotted time has expired and replaces him/her with the next speaker (302) waiting in the speakers' queue (2023). This is automatically and electronically accomplished by the speaker replacement function (5011) and the speakers' queue advancement function (5012). The moderator (303) or administrator (304) can also accomplish these tasks manually by touching or clicking the rotate/skip speaker button (5105) on their screens (101).

Should the moderator (303) or administrator (304) desire to interrupt or terminate a participant's (301) ability to send and receive text messages, he/she can activate the text chat disable function (5014) by simply touching or clicking the disable text chat window button (5012) on his/her screen (101). Similarly, should all participants (301) desire to engage in a private texting session with the moderator (303) or the administrator (304), he/she would simply touch or click the appropriate button on his/her screen (101) which would cause that participant's (301) icon on the moderator's (303) screen (101) to turn red and thereby signal that participant's (301) desire to have a private chat with the moderator (303) or administrator (304). The moderator (303) would simply touch or click on that participant's (301) icon to initialize a private text chat window (2030) that only that participant (301) and the moderator (303) or administrator (304) can see. Touching or clicking that participant's (301) icon activates the private text chat function (5015) thereby allowing him/her to send/receive private text messages to/from the moderator (303) or administrator (304) while excluding all other participants (301) from the private texting session.

### Technical Operation of the Preferred Embodiment

The technical operation of the preferred embodiment of the present invention entails a series of communications steps between the mobile communications device (10) and an Internet server (11). These communications steps are typically executed over a wireless connection, but can also be executed over a land-line connection such as high-speed Internet cable or a DSL connection. The present invention is configured as an application for the mobile communications device (10) that is either pre-installed in the mobile communications device (10) by its manufacturer or downloaded from the Internet by the participant (301).

The application is “launched” or enabled for the participant (301) by touching or clicking an icon affiliated with the present invention and located on the participant's screen (101). Touching or clicking the icon on the screen (101) initializes the application by sending a signal to the server (11) indicating that the participant (301) wants to join or participate in a videoconference using the functions contained in the present invention. This also establishes a data channel between the participant (301) and the server (11) which remains open for the duration of that participant's (301) time in the virtual meeting. The server (11) has similar data channels open to all other participants (301) for the duration of their respective time in the virtual meeting or teleconference as well. Using the keypad (102), the participant (301) types the URL address of the meeting or videoconference he/she wishes to join into the appropriate box and sends it to the server (11). Referring to FIGS. 3A and 3B, the server (11) responds by sending the participant (301) to the lobby (202L) for instructions on his/her screen (101) on how to participate in a virtual meeting or videoconference using the present invention. Using the keypad (102), the participant (301) types his/her screen name into the appropriate screen name input field (201B) and then touches or clicks the enter room button (2012). This sends a signal to the server (11) which adds the new participant's (301) screen name to the list of participants (301) in the selected virtual meeting or videoconference as seen on the left-hand side of the participants screen (2021) depicted in FIGS. 4B, and 5-7. The server (11) then sends the screen (101) images depicted in FIGS. 4B, 5, and 6 to all participants (301) [(the image seen in FIG. 7 is sent to the moderator (303) and/or administrator (304)] thereby notifying all participants (301) that a new participant (301) has joined the virtual meeting or videoconference. The relationship between the participant (301) and the server (11) thus far is a back-and-forth transaction of query-and-response through the data channel opened up between the two parties. However, once the participant (301) enters the virtual meeting room (20), the server (11) transmits any response to a query (such as a request to speak) to all participants (301).

Referring again to FIG. 3A, if the participant (301) does not know the URL address or is unsure of which meeting or videoconference he/she wants to attend, he/she would touch or click the visit lounge button (2011) which sends a signal to the server (11) to connect the participant (301) to a special demo room accessible by all visitors. The participant can use this demo room to familiarize himself with how the present invention works in practice

When the participant (301) touches or clicks the “enter room” button (2012), he/she is sending a message to the server (11) requesting it to electronically connect him/her to a virtual meeting or videoconference that is already in progress. The server (11) responds by electronically connecting the new participant (301) to the requested virtual meeting or videoconference and simultaneously notifying all participants (301) that a new participant (301) has joined the virtual meeting or videoconference. At this point, the new participant (301) has joined a virtual meeting or videoconference that was already in progress.

The participant (301) can review text messages sent by other participants (301) in the text chat window (2030). If the participant wishes to send a text message, he/she types the text message using the keypad (102) and then touches or clicks the send chat button (2032). This signals the server (11) that a text message is inbound; the server responds by posting the new text message in the text chat window (2030) of every participant (301).

When the participant (301) becomes the speaker (302), the server (11) automatically and electronically activates his/her microphone (103) and establishes a separate communications channel between the speaker (302), the server (11), and all other participants (301). While one channel remains open for the back-and-forth exchange of data bits such as requests to speak, sending a text message, or voting in a poll called for by the moderator (303), this channel is open but not “active” unless it is actually being used for transmitting a request from a participant (301) or a response from the server (11). The communications channel established for a speaker (302) transmits a data stream (as opposed to data bits) from the speaker (302) through the server (11) to all other participants (301). This channel is open and active as long as the speaker (302) is speaking.

The server (11) interacts with the moderator (303) or administrator (304) in the same manner as it does with the participant (301). There is an answer/reply exchange through a data channel when the moderator (303) or administrator (304) initializes one of its moderation/control functions (50). There is a video stream from moderator (303)/administrator (304) to server (11) and then from server (11) to all participants (301), including back to the moderator (303)/administrator (304), while the moderator (303) or administrator (304) is speaking or displaying graphic images.

### CONCLUSION, RAMIFICATIONS, AND SCOPE

The present invention as described herein has been designed to address the problems found in the prior art. Accordingly, the objects and advantages of the present invention are to provide an application for use in conducting group video conversations on mobile communications devices such as, without limitations, a mobile phone or computer tablet:
that limits the number of participants speaking in a virtual meeting to one at a time.
that determines the order of speakers and the length of time that they may speak.
wherein the participant's mobile communications device does not need other applications installed.
that is Internet specific.
that is targeted to an on-line remote group meeting audience.
that allows the moderator and participants in an on-line conference to talk to each other using Voice over IP technology.
that allows an on-line moderator to coordinate a verbal dialogue among individuals who are geographically dispersed.
that allows an on-line moderator to coordinate a verbal dialogue among individuals who are on-line.
that allows the participants in an on-line conference to learn more about the appeal and impact of their own products, advertisements, and political campaigns.
wherein entire groups can communicate collectively and simultaneously in a virtual environment.
wherein an observer can anonymously observe and listen to an ongoing Internet conference.
that provides the moderator of an on-line conference with innovative tools to manage the discussion more effectively than in a face-to-face meeting.
wherein an on-line program administrator can monitor and interact during sessions to provide technical and instructional assistance.
that allows an on-line moderator or administrator to remove abusive, uncooperative, vulgar, off-topic, etc. participants from the group video conversation.
that allows an on-line moderator or administrator to interrupt a speaker or remove a speaker during his/her presentation.
that allows the moderator and/or participants of an on-line conference to show videos, graphics and images to all participants simultaneously for group presentation and comment.
where the presentation capabilities of slides and videos is not limited to the size of the video image.
that allows hundreds of participants to join and partake in an on-line meeting, conference or discussion.
by determining the order of speakers and displaying that order of speaking in a “speakers' queue” that lets participants know the order in which speakers will be allowed to speak.
by providing participants with a means of entering a queue to participate by speaking one-at-a-time in an ordered fashion.
by providing participants with a means of communicating by text messages with the speaker as well as other participants while the speaker is actually speaking.
by providing an on-line moderator or administrator with a means of communicating by text messages with the speaker as well as other participants while the speaker is actually speaking.
by providing participants with a means of communicating privately with the moderator while an online remote meeting or discussion is in progress.

1. An application for moderating and controlling a group video conversation on mobile communication devices having an integral screen, a keypad, a microphone, a digital camera and a speaker embedded therein, said application downloaded into or imbedded in said mobile communication device's memory storage said application comprising the following moderating and controlling functions which permit a plurality of participants to engage in said group video conversation in an orderly manner:
(1) electronically providing said participants with access to an Internet site streaming said group video conversation,
(2) electronically allowing said participants to enter a virtual meeting room located on said Internet site, said virtual meeting room being where said group video conversation is taking place, and at least one of the following additional moderating and controlling functions:
(1) electronically providing said participants engaged in said group video conversation with an ability to request to speak to all other said participants,
(2) electronically and automatically placing said participants so requesting to speak in a speakers queue in chronological order of when said participants requested to speak,
(3) a means of electronically and automatically removing said participants individually and in chronological order on a one-by-one basis from said speakers' queue when it is said participant's turn to speak,
(4) electronically and automatically moving each of said participants so removed from said speaker's queue into a speaker's box which holds only one said participant at a time,
(5) electronically and automatically activate only one of said microphones on said mobile communication devices at a time, said activated microphone being that being used by said participant situated in said speaker's box,
(6) automatically and electronically display a live digital image of said participant in said speaker's box for the duration of said speaker's time in said speaker box,
(7) automatically and electronically deliver live audio from said microphone on said mobile communication device being used by said participant in said speaker's box to speakers located in said devices being used by all other said participants,
(8) electronically control how much time said participant will be allowed to speak in said speaker's box, and
(9) electronically and automatically terminate said participant's time in said speaker's box after said participant's allotted time for speaking has expired.

2. The application for moderating and controlling a group video conversation on a mobile communication device according to claim 1 further comprising a function to send text messages to said participants and a function to display said text messages to said participants on said screen found on said mobile communication device.

3. The application for moderating and controlling a group video conversation on a mobile communication device according to claim 1 wherein said mobile communication device is a computer tablet and said keypad is a manual keyboard.

4. The application for moderating and controlling a group video conversation on a mobile communication device according to claim 1 wherein said mobile communication device is a mobile phone and said keypad is embedded as a touch screen device.

5. The application for moderating and controlling a group video conversation on a mobile communication device according to claim 2 wherein said mobile communication device is a computer tablet and said keypad is a manual keyboard.

6. The application for moderating and controlling a group video conversation on a mobile communication device according to claim 2 wherein said mobile communication device is a mobile phone and said keypad is embedded as a touch screen device.

7. The application for moderating and controlling a group video conversation on a mobile communication device according to claim 1 further comprising a function permitting said participant to become an observer thereby being able to observe said group video conference without actually participating in it.

8. The application for moderating and controlling a group video conversation on a mobile communication device according to claim 7 wherein said mobile communication device is a computer tablet and said keypad is a manual keyboard.

9. The application for moderating and controlling a group video conversation on a mobile communication device according to claim 7 wherein said mobile communication device is a mobile phone and said keypad is embedded as a touch screen device.

10. The application for moderating and controlling a group video conversation on a mobile communication device according to claim 2 further comprising a function permitting said participant to become an observer thereby being able to observe said group video conference without actually participating in it.

11. The application for moderating and controlling a group video conversation on a mobile communication device according to claim 7 wherein said mobile communication device is a computer tablet and said keypad is a manual keyboard.

12. The application for moderating and controlling a group video conversation on a mobile communication device according to claim 7 wherein said mobile communication device is a mobile phone and said keypad is embedded as a touch screen device.

13. The application for moderating and controlling a group video conversation on a mobile communication device claim 1 further comprising additional moderating and controlling functions used exclusively by a moderator or administrator to maintain control over said group video conversation, said additional moderating and controlling functions being:
(1) electronically removing any said participant from said virtual meeting room at any given time,
(2) interrupting said participant speaking in said speaker's box, placing said moderator in said speaker's box while moving said participant from said speaker's box to a next-in-line position in said speaker's queue, allowing said moderator to speak, and then returning said participant from said next-in-line position in said speaker's queue to said speaker's box,
(3) interrupting said participant speaking in said speaker's box and removing said participant from said speaker's box and said speaker's queue,
(4) initiating private text message communications with a limited number of said participants said private text message not communicated to remaining said participants,
(5) electronically polling said participants and having said participants signal their responses to said polling,
(6) electronically adjusting volume coming from said speaker's box,
(7) electronically moving a participant waiting to speak in said speaker's queue to a position in line where said participant will be first in line to speak next,
(8) electronically storing visual aids in an assets folder,
(9) electronically removing said visual aids from said assets folder and posting said visual aids on said screen,
(10) electronically closing said assets folder,
(11) electronically muting said microphone being used by said participant in said speaker's box,
(12) electronically restoring audio from said microphone so muted,
(13) electronically to remove said speaker in said speaker's box and advance said participants in said speaker's queue accordingly,
(14) disabling said participants ability to engage in said text message communications,
(15) placing said moderator's cursor on said screens seen by all of said participants, and
(16) recording audio and video activities taking place in said virtual meeting room.

14. The application for moderating and controlling a group video conversation on a mobile communication device according to claim 13 wherein said mobile communication device is a computer tablet and said keypad is a manual keyboard.

15. The application for moderating and controlling a group video conversation on a mobile communication device according to claim 13 wherein said mobile communication device is a mobile phone and said keypad is embedded as a touch screen device.

16. A method of moderating and controlling participants in group video conversations on mobile communication devices having an application with participation, moderating, and control functions downloaded into or embedded in its memory storage, an integral screen, keyboard, digital camera, microphone, and speaker, said method comprising: the steps of:
(1) electronically providing said participants with access to an Internet site streaming said group video conversation,
(2) electronically allowing said participants to enter a virtual meeting room located on said Internet site, said virtual meeting room being where said group video conversation is taking place, and
at least one of the following steps:
(3) electronically providing said participants engaged in said group video conversation with an ability to request to speak to all other said participants,
(4) electronically and automatically placing said participants so requesting to speak in a speakers queue in chronological order of when said participants requested to speak,
(5) electronically and automatically removing said participants individually and in chronological order on a one-by-one basis from said speakers' queue when it is said participant's turn to speak,
(6) electronically moving each of said participants so removed from said speaker's queue into a speaker's box which holds only one said participant at a time,
(7) electronically and automatically activating only one of said microphones on said mobile communication devices at a time, said activated microphone being that being used by said participant situated in said speaker's box,
(8) automatically and electronically displaying a live digital image of said participant in said speaker's box for the duration of said speaker's time in said speaker box,
(9) automatically and electronically delivering live audio from said microphone on said mobile communication device being used by said participant in said speaker's box to speakers located in said devices being used by all other said participants,
(10) electronically controlling how much time said participant will be allowed to speak in said speaker's box, and
(11) electronically and automatically terminating said participant's time in said speaker's box after said participant's allotted time for speaking has expired.

17. The method of moderating and controlling participants in group video conversations on mobile communication devices according to claim 16 further comprising the steps of sending text messages to said participants and displaying said text messages to said participants on said screen found on said mobile communication device.

18. The method of moderating and controlling participants in group video conversations on mobile communication devices according to claim 16 further comprising at least one of the following steps used exclusively by a moderator or controller:
(1) electronically removing any said participant from said virtual meeting room at any given time,
(2) interrupting said participant speaking in said speaker's box, placing said moderator in said speaker's box while moving said participant from said speaker's box to a next-in-line position in said speaker's queue, allowing said moderator to speak, and then returning said participant from said next-in-line position in said speaker's queue to said speaker's box,
(3) interrupting said participant speaking in said speaker's box and removing said participant from said speaker's box and said speaker's queue,
(4) initiating private text message communications with a limited number of said participants said private text message not communicated to remaining said participants,
(5) electronically polling said participants and having said participants signal their responses to said polling,
(6) electronically adjusting volume coming from said speaker's box,
(7) electronically moving a participant waiting to speak in said speaker's queue to a position in line where said participant will be first in line to speak next,
(8) electronically storing visual aids in an assets folder,
(9) electronically removing said visual aids from said assets folder and posting said visual aids on said screen,
(10) electronically closing said assets folder,
(11) electronically muting said microphone being used by said participant in said speaker's box,
(12) electronically restoring audio from said microphone so muted,
(13) electronically removing said speaker in said speaker's box and advancing said participants in said speaker's queue accordingly,
(14) disabling said participants ability to engage in said text message communications,
(15) placing said moderator's cursor on said screens seen by all of said participants, and
(16) recording audio and video activities taking place in said virtual meeting room.

19. The method of moderating and controlling participants in group video conversations on mobile communication devices according to claim 18 wherein said mobile communication device is a tablet computer and said keypad is a manual keyboard.

20. The method of moderating and controlling participants in group video conversations on mobile communication devices according to claim 18 wherein said mobile communication device is a mobile phone and said keypad is embedded as a touch screen device.

21. A system for conducting group video conversations and meetings on mobile communication devices comprising:
a. a plurality of mobile communications devices (“MCDs”) each having an integral screen, a camera, a keypad, a microphone, and a mechanical speaker, each of said MCDs having an application downloaded into or embedded in its memory storage, thereby allowing participants in said group conversations and meeting to use said application to:
(1) perform the following routine participation or command functions:
(a) Enter room function,
(b) Start speaking function,
(c) Stop Speaking Function,
(d) Send text message function,
(e) Control speaker's volume function
(2) perform at least one of the following special participation or command functions:
(a) Raise-hand function,
(b) Ask to speak function
(c) Enter speakers' queue function
(d) Leave speakers' queue function
(e) Enter speakers' box function
(f) Leave speakers' box function
(g) Display visual aid function
(h) Remove Visual Aid Function
(i) Assign order of speakers' function
(j) Establish speaking time function
(k) Reset/modify speaking time function
(l) Mute participant(s) function
(m) Eject participant function
(n) Enable hand-polling function
(o) Interruption function
(p) Speaker replacement function
(q) Speakers' queue advancement function
(r) Asset display function
(s) Text chat disable function
(t) Private text chat function
(u) Open side chat with administrator button
(v) Mute user function
(w) Eject user function
(x) Rotate/skip to next speaker in line function
(y) Open assets folder function
(z) Close assets folder button
(aa) Show cursor function
(bb) Start/stop recording button
b. an Internet server,
c. a two-way data stream connecting said MCDs to said server and to each other, and
d. a virtual meeting room generated by said server that allows a plurality of participants using said MCDs to virtually enter said virtual meeting room to participate in said group conversations and meetings where only one of said participants can be speaking at any given time and an image of said participant who is speaking is the only image visible on any of said screens on said MCDs.

22. The system for conducting for conducting group video conversations and meetings on mobile communication devices according to claim 21 wherein said mobile communication device is a tablet computer and said keypad is a manual keyboard.

23. The system for conducting for conducting group video conversations and meetings on mobile communication devices according to claim 21 wherein said mobile communication device is a mobile phone and said keypad is embedded as a touch screen device.
